(19) United States
(12) Patent Application Publication
(10) Pub. No.: US 2021/0309373 A1
(43) Pub. Date: Oct. 7, 2021

(54) PERSONAL HEATING VENTILATION AND AIR CONDITIONING SYSTEM IN AIRCRAFT SEAT

(71) Applicant: B/E Aerospace, Inc., Winston-Salem, NC (US)

(72) Inventors: Mathieu LE CAM, Cobh, Co. Cork (IE); Catherine THIBAUD, South Windsor, CT (US); Mathew Robert PEARSON, Hartford, CT (US); Brian ST. ROCK, Andover, CT (US)

(21) Appl. No.: 17/221,069

(22) Filed: Apr. 2, 2021

(30) Foreign Application Priority Data
Apr. 7, 2020 (GB) 2005138.9

(51) Int. Cl. B64D 13/08

(52) U.S. Cl. CPC B64D 13/08

(57) ABSTRACT

A personal heating ventilation and air conditioning system (HVAC) for an aircraft seat includes at least one aircraft seat, a heating/cooling device disposed on the at least one aircraft seat and at least one branch configured to provide at least one flow path from the heating/cooling device. The system also includes at least one sub-branch provided within the at least one aircraft seat. The at least one sub-branch is configured to provide flow from the at least one branch through the at least one aircraft seat. The system also includes means for expelling air from the at least one sub-branch to an interior surface of the at least one aircraft seat.

### FOREIGN PRIORITY

This application claims priority to United Kingdom Patent Application No. 2005138.9 filed Apr. 7, 2020, the entire contents of which is incorporated herein by reference.

### TECHNICAL FIELD

The present disclosure relates to aircraft seating arrangements and, in particular, personal heating ventilation and air conditioning systems in aircraft seats.

### BACKGROUND

Climate control of living and working spaces is traditionally provided to relatively large areas, including unoccupied zones, such as entire buildings, offices or suites of rooms within a building. In the case of vehicles, such as aircrafts, the entire cabin is usually cooled or heated as a unit. However, there are many situations in which it can be more beneficial to have more selective and dedicated control over the near environment of each passenger. For example, it is often desirable to provide a personal climate control to a passenger for an improved comfort and flight experience.

Currently, passengers on commercial aircrafts have control on the gaspers providing fresh air from the above head area. The small nozzles are difficult to reach and adjust to meet the passenger's needs in terms of flow and direction. One temperature set-point is controlled by the cabin crew for the whole cabin area, including unoccupied zones such as volume above heads, the galleys or the aisles.

Further, even with the gaspers oriented towards the head and torso, the passenger's back and other pressure points may remain sweaty while being seated for a few flight hours or after being exposed to hot outdoor conditions of a summer day (e.g. when boarding the aircraft). In winter, the gaspers may provide cold air which may be uncomfortable after boarding the aircraft on a cold winter day.

For such reasons, various types of personal seat control systems were developed mainly in the automotive sector. However, there is a need for an improved control device for a personalised micro-climate in aircraft seats.

### SUMMARY OF THE INVENTION

In one aspect, there is provided a personal heating ventilation and air conditioning system (HVAC) for an aircraft seat. The personal HVAC system includes at least one aircraft seat, a heating/cooling device disposed on the at least one aircraft seat, at least one branch configured to provide at least one flow path from the heating/cooling device, at least one sub-branch provided within the at least one aircraft seat, wherein the at least one sub-branch is configured to provide flow from the at least one branch through the at least one aircraft seat, and means for expelling air from the at least one sub-branch to an interior surface of the at least one aircraft seat.

The heating/cooling device may be one of a combination at least one thermoelectric device and at least one fan, or a combination of at least one heating pad and at least one fan.

The means for expelling air may include one of at least one outlet and/or a plurality of holes.

Further, the at least one aircraft seat may include at least one of a seat cushion, a seat back support, a seat neck support and/or a headrest. The at least one aircraft seat may include a first seat, a second seat and a third seat.

Preferably, the at least one branch may include a first branch, a second branch, and a third branch. The first branch may have a first sub-branch and a second sub-branch, and the second branch may have a first sub-branch and a second sub-branch, and the third branch may have a first sub-branch and a second sub-branch.

The heating/cooling device may be controlled by a controller. Preferably, the system may further include manual mechanic controls for adjusting the heating/cooling device through the controller; and/or a tablet connected to an advanced control system for adjusting the heating/cooling device; and/or a smart phone connected to an advanced control system for adjusting the heating/cooling device.

Further, the at least one sub-branch may be adjustable.

Preferably, the at least one aircraft seat may include a material provided over the seat, and wherein there may be an air spacer material provided between the material and the means for expelling air.

In another aspect, there is provided an aircraft cabin including at least one personal HVAC system as described above.

In a further aspect, there is provided a method that includes providing at least one aircraft seat, providing a heating/cooling device on the at least one aircraft seat, providing at least one branch that provides at least one flow path from the heating/cooling device, providing at least one sub-branch within the at least one aircraft seat, wherein the at least one sub-branch provides flow from the at least one branch through the at least one aircraft seat, and expelling air from the at least one sub-branch to an interior surface of the at least one aircraft seat.

### BRIEF DESCRIPTION OF THE DRAWINGS

FIG. 1 shows an example of a seating arrangement with a personal heating ventilation and air conditioning (HVAC) system.

FIG. 2 shows an assembly composed of thermoelectric devices, heat sinks and fans, both from a bird's eye view and as a cross section, for use in the seating arrangement shown in FIG. 1.

FIG. 3 shows an example of a seat that may be used in the seating arrangement shown in FIG. 1.

FIG. 4A shows the interior of the seat cushion shown in the seat of FIG. 3.

FIG. 4B shows an example of another side of the interior of the seat cushion shown in the seat of FIG. 3.

FIG. 5 shows an example of material used to cover the seat shown in FIG. 3.

### DETAILED DESCRIPTION

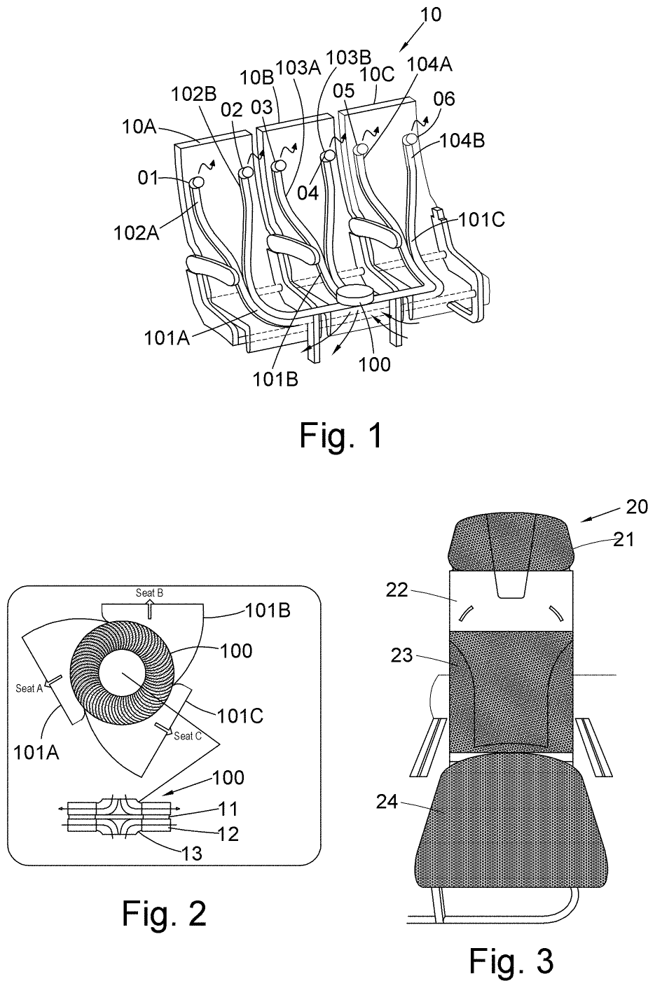

Referring now to FIG. 1, there is shown an example of a seating arrangement 10. The seating arrangement 10, as shown in this example, relates to seats for use in an aircraft. As shown in FIG. 1, the seating arrangement 10 may include a first seat 10A, a second seat 10B and a third seat 10C. Although in the example shown in FIG. 1, there are three seats 10A, 10B and 10C in the seating arrangement 10, it is envisaged that there could be any number of seats that are required for the aircraft. For example, if the personal HVAC is required in a business class seat, there would only necessarily be one seat in the seating arrangement. Also, if the row of seats on the desired aircraft requires more than three seats in the seating arrangement, it is envisaged that there may be less than, or more than, three seats. Therefore, FIG. 1 is not restricted to a three seat arrangement, such as the seating arrangement 10 including a first seat 10A, a second seat 10B and a third seat 10C.

As shown in FIG. 1, there may be provided a heating/cooling device 100 on the underside of second seat 10B. Again, as discussed above, the heating/cooling device 100 may be provided on the underside of one seat or more than three seats, where necessary. Further, although there is only one heating/cooling device 100 shown in FIG. 1, it is envisaged that there may be more than one heating/cooling device 100 on any number of desired seats. In the example shown in FIG. 1, the heating/cooling device is provided on the underside of the middle seat (i.e., the second seat 10B).

In the example shown in FIG. 1, the heating/cooling device 100 may include a first outlet, a second outlet and a third outlet (not shown). The first outlet may be connected to a first branch 101A providing a first flow path. The second outlet may be connected to a second branch 101B providing a second flow path. The third outlet may be connected to a third branch 101C providing a third flow path. The first, second and third flow path allow for heating or cooling air to flow through the first, second and third branches 101A, 101B and 101C.

Also, as shown in FIG. 1, the first branch 101A may split into a first sub-branch 102A and a second sub-branch 102B which may provide flow through a seat cushion, a seat back support and a seat neck support of the first seat 10. Similarly, the second branch 101B may split into a first sub-branch 103A and a second sub-branch 103B which may provide flow through a seat cushion, a seat back support and a seat neck support of the second seat 10B. The third branch 101C may also split into a first sub-branch 104A and a second sub-branch 104B which may provide flow through a seat cushion, a seat back support and a seat neck support of the third seat 10C.

In an example shown in FIG. 1, there may be provided one or more outlets O1, O2, O3, O4, O5 and O6 on the sub-branches 102A, 102B, 103A, 103B, 104A and 104B. The one or more outlets O1 . . . O6 may be provided to expel air to an interior surface of one or more of the first seat 10A, the second seat 10B and the third seat 10C. In the example shown in FIG. 1, the outlets O1 . . . O6 are directed to expel air to the seat back support through nozzles (not shown) above the shoulders. However, it is envisaged that the outlets O1 . . . O6 could also expel air through the seat neck support, entire seat back support and/or the seat cushion.

Although not shown in FIG. 1, and as an alternative, or in addition to the outlets O1 . . . O6 described above, the sub-branches 102A, 102B, 103A, 103B, 104A and 104B may include a plurality of holes along their surfaces to expel air from the sub-branches 102A, 102B, 103A, 103B, 104A and 104B. This would allow for air to be expelled alone their surfaces to one or more of the seat cushion, seat back support and seat neck support. It is to be understood that when the sub-branches 102A, 102B, 103A, 103B, 104A and 104B extend into the interior of the seat where there is a seat neck support, and the seat neck support is adjustable, the sub-branches 102A, 102B, 103A, 103B, 104A and 104B may also adjust with a telescopic arm with the adjustment of the seat neck support. As an example, the sub-branches 102A, 102B, 103A, 103B, 104A and 104B, when supplying air to the back of the head are designed to be adjustable to passengers of varying sizes. The design is integrated in the headrest. The assembly may be composed of an air spacer material and perforated leather similar to the seat cushion assembly described below.

FIG. 2 shows an example of the heating/cooling device 100 of FIG. 1. Here, it can be seen that the heating/cooling device 100 includes the first branch 101A, the second branch 101B and the third branch 101C. A cross-section of the exemplary heat exchanger 100 can be seen also in FIG. 2. In this example, there is provided a layer of thermoelectric devices 11, heat sinks 12 and heat rejection side-blower 13. These layers provide for active cooling/heating for expelled air through the first branch 101A, the second branch 101B and the third branch 101C. In the example shown in FIG. 2, the heating/cooling device 100 is a layer of thermoelectric devices for conditioning the air. Alternatively, the heating/cooling device 100 can be dedicated to one seat only and duplicated for each seat. Another alternative, or additional feature, of the heating/cooling device 100 may be a combination of convective cooling with fans (not shown) only and resistive heating with heating pads (not shown). As an example, the heating pads can be integrated in the seat cushion and seat back support. The heating/cooling device could also be used as a cooling purposes only with a fan (not shown) delivering air to the different areas. Further, the fans (not shown) may also be directly integrated in each area; seat cushion, seat back support, seat neck support and headrest.

As an example, the heating/cooling device may comprise a thermoelectric based heat pump configuration, such as that described in US 2018/0216855.

Referring now to FIGS. 1 and 2, it is envisaged that the heating/cooling device 100 can be adjusted by a passenger when sitting in, for example, one of the first seat 10A, the second seat 10B or the third seat 10C. Controls (not shown) may be electrically connected to the heating/cooling device 100 to alter the heating and/or cooling of the specific seat in which the passenger is sat. In this example, the passenger could manually adjust the heating and/or cooling from the seat in which they are sat by pressing the controls (not shown). Additionally, a tablet or smart phone may be connected to an advanced control system (not shown) in order to adjust the heating and/or cooling on the seat in which the passenger is sat.

Turning now to FIG. 3, there is shown an example of a seat 20 that could be provided as a first seat 10A, a second seat 10B or a third seat 10C of FIG. 1. As can be seen in FIG. 3, the seat 20 includes a seat cushion 24, a seat back support 23, a seat neck support 22 and a seat head support 21. It is envisaged that the sub-branches 102A, 102B, 103A, 103B, 104A and 104B could be provided throughout the seat cushion 24, the seat back support 23, the seat neck support 22 and the seat head support 21. Again, as described above, when the sub-branches 102A, 102B, 103A, 103B, 104A and 104B are provided in an adjustable zone (e.g. the seat head support 21), the sub-branches 102A, 102B, 103A, 103B, 104A and 104B can also adjust with movement of the adjustable zone. Therefore, the passenger can enjoy the heating/cooling after adjusting for comfort.

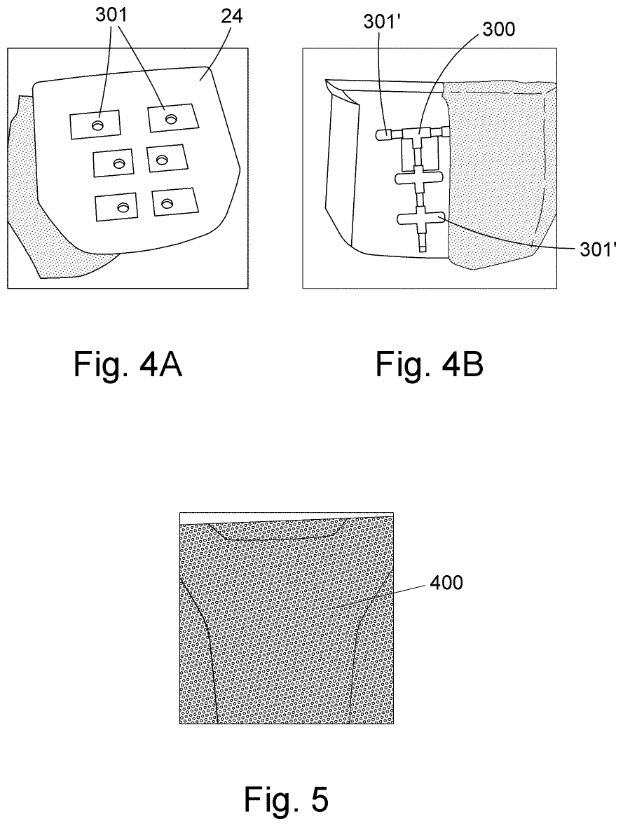

FIGS. 4A and 4B show an example of an air distribution pad 300 that can be used in addition to the first branch 101A, second branch 101B and third branch 101C of FIG. 1. The air distribution pad 300 is shown here to be in the interior of the seat cushion. The air distribution pad 300 may include one or more nozzles 301 for expelling air to the seat cushion 24. As shown in FIG. 4B, the air distribution pad 300 may include one or more branches 301′ for providing air flow to the one or more nozzles 301. The air distribution pad 300 may be fluidly connected to the first branch 101A, the second branch 101B and/or the third branch 101C shown in FIG. 1. The air distribution pad 300 alternatively may be fluidly connected to the sub-branches 102A, 102B, 103A, 103B, 104A and 104B.

FIG. 5 shows an example of the material 400 which is provided over the seat. In this Figure, it is shown that the material 400 may be perforated to allow for the air to expel through the seat material 400. In an example, the material 400 may be perforated leather. Of course, other materials are also envisaged and the material 400 is not limited to leather. In addition to the material 400, there may be provided an air spacer material (not shown) between the material 400 and the outlets O1 . . . O6 or plurality of holed that expel air. In this way, the air spacer material acts as a mesh to prevent passengers from blocking the outlet whilst sitting in the seat.

Although the invention has been described in terms of preferred embodiments as set forth above, it should be understood that these embodiments are illustrative only and that the claims are not limited to those embodiments. Those skilled in the art would be able to make modifications and alternatives in view of the disclosure which are contemplated as falling within the scope of the appended claims.

1. A personal heating ventilation and air conditioning system (HVAC) for an aircraft seat, comprising:
at least one aircraft seat;
a heating/cooling device disposed on the at least one aircraft seat;
at least one branch configured to provide at least one flow path from the heating/cooling device;
at least one sub-branch provided within the at least one aircraft seat, wherein the at least one sub-branch is configured to provide flow from the at least one branch through the at least one aircraft seat; and
means for expelling air from the at least one sub-branch to an interior surface of the at least one aircraft seat.

2. The personal HVAC system of claim 1, wherein the heating/cooling device is one of a combination at least one thermoelectric device and at least one fan, or a combination of at least one heating pad and at least one fan.

3. The personal HVAC system of claim 1, wherein the means for expelling air includes one of at least one outlet and/or a plurality of holes.

4. The personal HVAC system of claim 1, wherein the at least one aircraft seat includes at least one of a seat cushion, a seat back support, a seat neck support and/or a headrest.

5. The personal HVAC system of claim 1, wherein the at least one aircraft seat includes a first seat, a second seat and a third seat.

6. The personal HVAC system of claim 1, wherein the at least one branch comprises a first branch, a second branch, and a third branch.

7. The personal HVAC system of claim 6, wherein the first branch has a first sub-branch, a second sub-branch, and wherein the second branch has a first sub-branch and a second sub-branch, and wherein the third branch has a first sub-branch and a second sub-branch.

8. The personal HVAC system of claim 1, wherein the heating/cooling device is controlled by a controller.

9. The personal HVAC system of claim 8, further comprising:
manual mechanic controls for adjusting the heating/cooling device through the controller; or
a tablet connected to an advanced control system for adjusting the heating/cooling device; or
a smart phone connected to an advanced control system for adjusting the heating/cooling device.

10. The personal HVAC system of claim 1, wherein the at least one sub-branch is adjustable.

11. The personal HVAC system of claim 1, wherein the at least one aircraft seat includes a material provided over the seat, and wherein there is provided an air spacer material provided between the material and the means for expelling air.

12. An aircraft cabin comprising at least one personal HVAC system as recited in claim 1.

13. A method, comprising:
providing at least one aircraft seat;
providing a heating/cooling device on the at least one aircraft seat;
providing at least one branch that provides at least one flow path from the heating/cooling device;
providing at least one sub-branch within the at least one aircraft seat, wherein the at least one sub-branch provides flow from the at least one branch through the at least one aircraft seat; and
expelling air from the at least one sub-branch to an interior surface of the at least one aircraft seat.

14. The method of claim 13, wherein the heating/cooling device is one of a combination at least one thermoelectric device and at least one fan, or a combination of at least one heating pad and at least one fan.
